(19) United States
(12) Patent Application Publication
(10) Pub. No.: US 2024/0393016 A1
(43) Pub. Date: Nov. 28, 2024

(54) GUIDE SYSTEM FOR A BALL JOINT ASSEMBLY OF THERMOSOLAR PLANTS

(71) Applicant: COBRA INSTALACIONES Y SERVICIOS, S.A., Madrid (ES)

(72) Inventor: José Carlos CANCHO VERA, Madrid (ES)

(73) Assignee: COBRA INSTALACIONES Y SERVICIOS, S.A., Madrid (ES)

(21) Appl. No.: 18/674,899

(22) Filed: May 26, 2024

(30) Foreign Application Priority Data
May 26, 2023 (ES) U202330915

(51) Int. Cl. F24S 30/00

(52) U.S. Cl. CPC F24S 30/00; F24S 2030/17

(57) ABSTRACT

A guide system comprising a mechanism formed by a support, fixed to the manifold, and a spring that joins said support to the arm formed by the connection tubes provided between the absorption tube and the fixed tube of the plant, whereby this mechanism keeps said arm linked to the manifold, tending to maintain a design position due to tension exerted by said spring; and a rotation angle limiting mechanism, installed in the intermediate ball joint, which limits the movement thereof, guiding the arm in its movement in order to correct a rotation position of the output ball joint.

### FIELD OF THE INVENTION

The invention falls within the solar energy sector, in particular, parabolic trough thermosolar installations, and it is specifically developed for single ball joint assemblies in the solar farm.

### BACKGROUND OF THE INVENTION

A parabolic trough thermosolar plant is an installation intended for the transformation of solar energy into electricity through a conventional thermodynamic cycle. A thermosolar power plant concentrates solar radiation to heat a thermal fluid called HTF (Heat Transfer Fluid), which through heat exchangers raises the temperature of the water until it turns into steam. Afterwards, the water steam is led to a turbine, where the thermal energy is converted into mechanical energy, which is transmitted to an alternator where its final transformation into electrical energy takes place. A manifold thermosolar power plant captures the sun's rays through concentration or high-temperature manifolds.

The manifolds used to capture and concentrate the sun's rays are large mirror surfaces, generally formed with a certain curvature, which constantly track the sun, such that the reflected rays hit at all times an absorption tube through which a heat transfer fluid (HTF) circulates, which is heated to temperatures of about 400° C. The heated fluid in the absorption tube passes to the plant's piping system, which maintains a fixed position at all times, through flexible arms or ball joint assemblies with ball joints, so that any of these systems can absorb the movements that occur in the absorption tube, on the one hand, due to the axial expansion caused by the heating of the fluid, and on the other hand, to its rotation with the corresponding solar tracker.

WO2009047248 (A1) is one of the classic examples of a connection device between the absorption tube and the fixed tube of a thermosolar plant, by means of a flexible tube. On the contrary, document U.S. Pat. No. 4,934,324 (A) describes a connection between the manifold tube with the input and output pipes of said manifold, through a series of fluid-tight rotary joints (ball joints), which allow free biaxial rotation movement of the manifold pipe with the panel manifold.

Several designs have also been put into practice in which the hot fluid output pipe has been equipped with several ball joints, in order to facilitate the axial and longitudinal displacement of the absorption tube, due to the heating of the fluid and the movement of the tracker. However, there is a persistent problem in couplings of this type, since the aforementioned ball joints, when working for a long time under extreme conditions (maximum angles of the ball joint) and as far as their movement is concerned, become blocked and sometimes the connection tube breaks, thereby causing significant vaporisation, HTF (flammable and highly polluting oil) spills, and even fires.

### DESCRIPTION OF THE INVENTION

Based on the prior art, an objective of the present invention is to provide a single ball joint assembly that makes up the device for connecting and guiding the absorption tube with the plant pipes, which solves the problem mentioned in the previous point. In order to achieve the proposed objectives, the invention proposes a device which has the features of claim 1.

The invention is intended to be incorporated into a piping system comprising several ball joints, called single ball joint assemblies, which allow the movements of said pipes to adapt to the axial and longitudinal displacement of the absorption tube and to the movement of the tracker, which incorporates a support, fixed to the tracker, with a spring that keeps it linked to the ball joint assembly so it tends to always remain in its design position. On the other hand, this device also comprises a rotation angle limiter, which guides the arm, together with the support and spring, which forms the connection tube in its movement; this limiter consists of a conical bushing that is installed in the middle ball joint of the single arm to limit the movement of said ball joint, correcting the rotation position of the output ball joint, not reaching maximum rotation angles, in order to avoid its seizure when working within the limits marked by the manufacturer.

### DESCRIPTION OF THE FIGURES

As a complement to the description provided herein, and for the purpose of helping to make the features of the invention more readily understandable, the present specification is accompanied by a set of drawings which, by way of illustration and not limitation, represent the following:

FIG. 1 represents respective front and side elevation views of the piping system that makes up the connection device for connecting the absorption tube (1) with the plant pipes (9).

FIG. 2 shows the ball joint (4) located in the middle of the ball joint assembly formed by the tubes coupling the absorption tube (1) with the plant pipes (9), in two positions, with the plant cold and in operation at high temperature.

FIG. 3 represents a general view of the conical bushing (11) that limits the movement of the middle ball joint (4).

### PREFERRED EMBODIMENT OF THE INVENTION

As can be seen in the referenced figures, the single ball joint assembly in thermosolar plants forms a device for connecting the absorption tube (1) with the plant pipes (9), said assembly formed by respective tubes (3, 5) between which three ball joints are arranged, connected to said tubes through elbows. An input ball joint (2) couples to the absorption tube (1), an output ball joint (6) couples to the plant piping system (9), and an intermediate ball joint (4) joins to the end ball joints (2, 6) through the tubes (3, 5).

This device comprises two essential mechanisms to achieve the objective of the present invention: on the one hand, a support (10) fixed to the manifold, which is connected to the arm formed by the connection tubes (3, 5) provided between the absorption tube (1) and the fixed tube (9) of the plant by means of a spring (8), which keeps said arm linked to the manifold so that it maintains its position without separating therefrom; and, on the other hand, a rotation angle limiter, installed in the intermediate ball joint (4) limiting the movement thereof, guiding the arm in its movement in order to correct the rotation position of the output ball joint (6), so that it operates within the marked limits.

In a preferred embodiment, the spring support (8) is linked to the tube (5) that connects the intermediate ball joint (4) to the output ball joint (6).

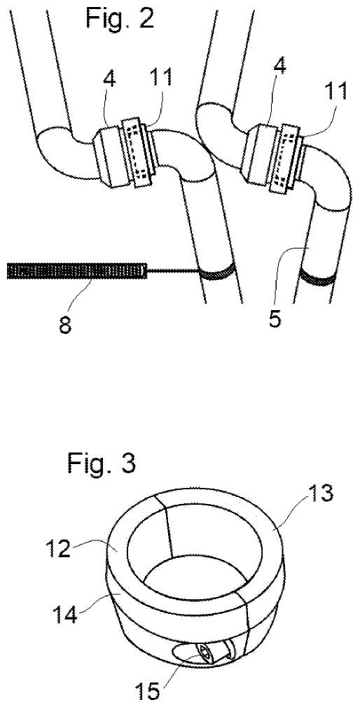

In a preferred embodiment, the limiter installed in the intermediate ball joint (4) consists of a conical bushing (11) limiting the rotation of the output tube (5) beyond a preset angle. (See FIG. 2)

As shown in FIG. 3, the conical bushing (11) is divided by a diametral plane into two parts (12, 13) linked by means of at least two screws (15) tangential to said bushing. This conical bushing (11) has a conical area (14) that is inserted into the intermediate ball joint (4) to limit its movement, and a cylindrical portion located towards the outside in which the tangential holes are located in which the two parts (12, 13) that make up this bushing are fixed by means of at least two screws (15).

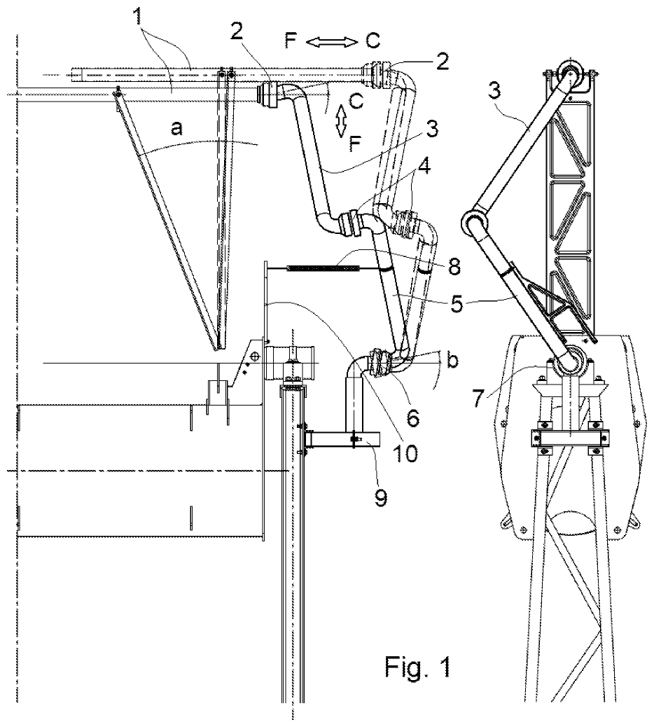

FIG. 1 shows the effect of this device. The arm formed by the tubes (3, 5) and the intermediate ball joint (4) is placed with the cold thermosolar plant (position F) towards the inside of the manifold, but when its temperature raises (position C) the absorption tube (1) dilates towards the side, which forces the entire arm to tilt towards the side and rise slightly, all of this due to the joints provided by the ball joints (2, 4, 6). And, it is in position (C) where the output ball joint (6) can become seized, unless this problem is corrected with the two aforementioned mechanisms: the spring-loaded support (8) and the conical bushing (11) placed on the intermediate ball joint (4).

Having sufficiently described the nature of the invention, in addition to a preferred exemplary embodiment, it is hereby stated for the relevant purposes that the materials, shape, size and layout of the described elements may be modified, provided that it does not imply altering the essential characteristics of the invention claimed below:

1. A guide system for a ball joint assembly of thermosolar plants, which constitutes the connection means for connecting the absorption tube with a fixed tube of a thermosolar plant, said assembly formed by respective tubes between which three ball joints are arranged: an input ball joint that couples to the absorption tube, an output ball joint that couples to the plant piping system, and an intermediate ball joint that joins to the end ball joints through the tubes, wherein said guide system comprising:
a mechanism formed by a support, fixed to the manifold, and a spring that joins said support to the arm formed by the connection tubes provided between the absorption tube, and the fixed tube of the plant, by means of which this mechanism keeps said arm linked to the manifold, tending to maintain a design position due to tension exerted by said spring; and
a rotation angle limiting mechanism, installed in the intermediate ball joint, which limits the movement thereof, guiding the arm in its movement in order to correct a rotation position of the output ball joint.

2. The guide system, according to claim 1, wherein the support with spring is linked to the tube, which connects the intermediate ball joint with the output ball joint.

3. The guide system, according to claim 2, wherein a limiter installed in the intermediate ball joint consists of a conical bushing that limits the rotation position of the output tube beyond a preset angle.

4. The guide system, according to claim 3, wherein the conical bushing is divided by a diametral plane into two parts linked by means of at least two screws tangential to said bushing.

5. The guide system, according to claim 4, wherein the conical bushing has a conical area towards an inside of the ball joint and towards an outside having a cylindrical area, in which tangential holes are located, in which the two parts are fixed by means of at least two screws.

6. The guide system, according to claim 1, wherein a limiter installed in the intermediate ball joint consists of a conical bushing that limits the rotation of the output tube beyond a preset angle.

7. The guide system, according to claim 3, wherein the conical bushing has a conical area towards an inside of the ball joint and towards an outside having a cylindrical area, in which tangential holes are located, in which the two parts are fixed by means of at least two screws.
